(19) United States
(12) Patent Application Publication
(10) Pub. No.: US 2004/0083158 A1
(43) Pub. Date: Apr. 29, 2004

(54) Systems and methods for distributing pricing data for complex derivative securities

(76) Inventors: Mark Addison, Redhill (GB); Derek Kilfedder, Clapham (GB); Richard Derbyshire, Syston Leicester (GB); Phillip Carter, London (GB)

Correspondence Address: Lowenstein Sandler, 65 Livingston Avenue, Roseland, NJ, 07068, US

(21) Appl. No.: 10/393,789

(22) Filed: Mar. 21, 2003

Related U.S. Application Data
(60) Provisional application No. 60/417,368, filed on Oct. 9, 2002.

(51) Int. Cl. G06F 17/60

(52) U.S. Cl. 705/37

(57) ABSTRACT

Methods and systems for providing network-based trading platforms with a continuous stream of up-to-date pricing date for derivatives by way of an externally based pricing-engine system. The pricing engine receives and process feeds of up-to-date information to derive up-to-date pricing data for complex derivative securities. Preferably, the up-to-date information feed is received in real time from a network-based source. The methods and systems of the invention then write the derived pricing data to the locations in cache memory of a network-based trading platform where pricing data is read.

This application claims the benefit of U.S. Provisional Application No. 60/417,368 filed Oct. 9, 2002, which application is hereby incorporated herein by reference.

### 1. FIELD

The invention relates to methods and systems for pricing derivative securities and automatically transmitting the pricing data to network-based trading platforms for use by investors. The invention is particularly useful for continuous pricing of complex derivatives based on up-to-date information.

### 2. BACKGROUND

A derivative security is a financial instrument whose value is based on one or more underlying commodities or assets, such as stocks, bonds, real estate, mortgages (interest rates), currency, or precious metals. Derivative securities generally relate to the right to buy or sell a specified amount of one or more underlying commodities at a specified price within a specified time or on a specified date. Common examples of derivative securities include options, warrants, and futures contracts.

Options contracts give a holder the right to buy or sell a specified amount of an underlying security at a specified price within a specified time. The parties of options contracts are purchasers who acquire rights and sellers who assume obligations. A call option gives the owner the right to buy the underlying security, whereas a put option gives the owner the right to sell the underlying security. There is typically an up-front, nonrefundable premium to obtain the option rights. A warrant is an option issued by a company; typically, it is a call warrant issued on their own stock. Thus, a warrant is an agreement between a company and another party entitling the party to buy the company's stock within a specified period at a certain price.

A futures contract is a standardized contract to make or take delivery of a commodity or financial instrument at a predetermined time and place. Thus, a futures contract locks in a price for a future date. Some of the most popular futures contracts traded in the United States are equity-based contracts relating to the Dow Jones Industrial Average; interest rate contracts relating to Treasury bonds and Treasury notes; agricultural contracts, relating to corn, soybeans, and wheat; and contracts relating to precious metals, such as silver and gold.

Derivative securities are purchased and sold by investors. Financial institutions often wish to offer unique, complex, or exotic derivative securities to hedge or minimize risks associated with their individual portfolio. One example of an exotic option is the “basket option”, where the payoff is dependent on the value of a portfolio of assets. Generally, however, the market does not price such exotic or complex derivative securities because they are traded so infrequently. But before investors are willing to trade such complex derivative securities in an open market, they require access to reliable pricing information.

Network-based trading platforms that provide automated trading services are currently available to investors. With an automated system, a trader may enter an order to buy or sell, which is transmitted to the central system of the applicable exchange. There, it is matched with another trader who is willing to sell or buy the same securities. The computer then confirms the completion of the transaction to each trader. For example, the company Orc Software (http://www.orcsoftware.com) markets standardized software and provides architecture for pricing and trading derivative securities in real time. Orc has access to many investors and allows subscribers to trade simultaneously on more than thirty-five marketplaces around the world. But Orc and other third-party investor services do not provide methods for financial institutions to offer up-to-date pricing data for complex derivative securities because the services do not have suitable architecture. Such services typically incorporate simple, limited internal pricing models. The models suffer because they cannot be user modified, for example, to accept and process additional data feeds.

The failure of network-based trading platforms to provide sophisticated derivative-pricing services, which provide up-to-date pricing based on the latest facts, is primarily due to the complexity of the required pricing models. The relationship between the value of a derivative security and the underlying assets is not linear and the complexity and difficulty of valuating derivative securities increases considerably with the number of underlying assets. Numerous pricing models and engines have been developed to valuate derivative securities, many of which are capable of valuating very complex derivative securities. The Black-Scholes option-pricing model has been one of the most influential. The Black-Scholes model is based on stochastic calculus and is described in a variety of references, such as NEIL A. CHRISS, THE BLACK-SCHOLES AND BEYOND INTERACTIVE TOOLKIT: A STEP-BY-STEP GUIDE TO IN-DEPTH OPTION PRICING MODELS (1997). A general discussion of derivative pricing models is presented in LES CLEWLOW & CHRIS STRICKLAND, IMPLEMENTING DERIVATIVES MODELS (1998). Of course, the risks in relying on any model include errors in the model's underlying assumptions, calculation errors, and failure to account for variables that affect the underlying assets.

A financial institution that offers complex derivative products must be able to obtain and provide accurate pricing so that the derivatives can be readily traded and so the institution can manage its risk. When the derivative is unique and complex, and hence tricky to price, hedging is very difficult. One approach to such hedging involves measuring different dimensions of risk in an option position. This process is commonly referred to as managing the “greeks”. Each greek corresponds to a dimension of risk. The trader's objective is to manage the greeks so that all risk dimensions are acceptable. Sophisticated hedging schemes often involve calculating greeks such as delta, theta, gamma, and vega.

The greek delta “Δ” for an option is defined as the rate of change of the option price with respect to the price of the underlying assets.

Theta “θ” is the rate of change of the value of the portfolio with respect to the passage of time with all else remaining the same.

Gamma “F” is the rate of change of the portfolio's delta with respect to the price of the underlying asset. Thus, it is the second partial derivative of the portfolio with respect to asset price.

Vega “ν” is the rate of change of the value of a portfolio with respect to the volatility of the underlying assets. The volatility is represented by sigma “σ”, which is a measure of the uncertainty of a stock's future price. Volatility is generally thought to be caused by trading trends and the random arrival of new information regarding the future returns from the stock. The greater the volatility, the greater the dispersion of the return around its expected value and the greater the difficulty to track the share price.

To summarize, financial institutions are prepared to offer investors increasingly complex derivative securities; reliable pricing models and pricing engines have been developed; and network-based trading platforms provide automated investor trading services. But, unfortunately, the investor trading platforms do not provide up-to-date prices of complex derivatives so that investors can trade them on the open market. The net effect is that while trading platforms have access to many investors—many who wish to purchase complex derivative securities—these platforms cannot offer complex derivative securities for public trading because they lack the engines and architecture to run complex derivative pricing models in real time.

What is needed are systems and methods that continually price complex derivative securities based on current information such as the underlying commodities' real-time market prices. What is especially needed are such systems and methods adapted to connect to network-based trading platforms accessible to a large investor audience, thereby permitting open-market trading of the complex derivative securities.

### 3. SUMMARY

The invention is directed to systems and methods for pricing derivative securities and automatically transmitting the pricing data to network-based trading platforms. The systems and methods of the invention are useful to widely offer investors up-to-date pricing data, through network-based trading platforms, for complex and exotic derivative securities. Using the methods and systems of the invention, investors can make informed decisions to buy and sell complex derivative securities and financial institutions can better manage the risks associated with offering complex derivative securities.

In one embodiment, the methods and systems of the invention seamlessly interface with network-based trading platforms to provide up-to-date pricing data for complex derivative securities. Preferably, the network-based trading platforms have a large customer base.

In another embodiment, the methods and systems of the invention employ an externally based pricing engine to receive and process up-to-date information to derive up-to-date pricing data for complex derivative securities. Preferably, the up-to-date information is received as a continuous stream, more preferably, in real time, from network-based sources. The methods and systems of the invention then write the derived pricing data to the locations in cache memory of a network-based trading platform where pricing data is read.

### 4. BRIEF DESCRIPTION OF THE FIGURES

These and other features, aspects, and advantages of the present invention will become better understood with regard to the following description, appended claims, and accompanying drawings where:

FIG. 1 is a flow chart that outlines an embodiment of the invention for valuing complex derivatives and automatically transmitting the pricing data to a third-party;

FIG. 2 is a diagram summarizing the architecture of methods and systems of the invention;

FIG. 3 is a diagram summarizing the hardware of a pricing-engine system for use in the invention; and

FIG. 4 is a diagram summarizing the software of a pricing-engine system for use in the invention.

### 5. DETAILED DESCRIPTION

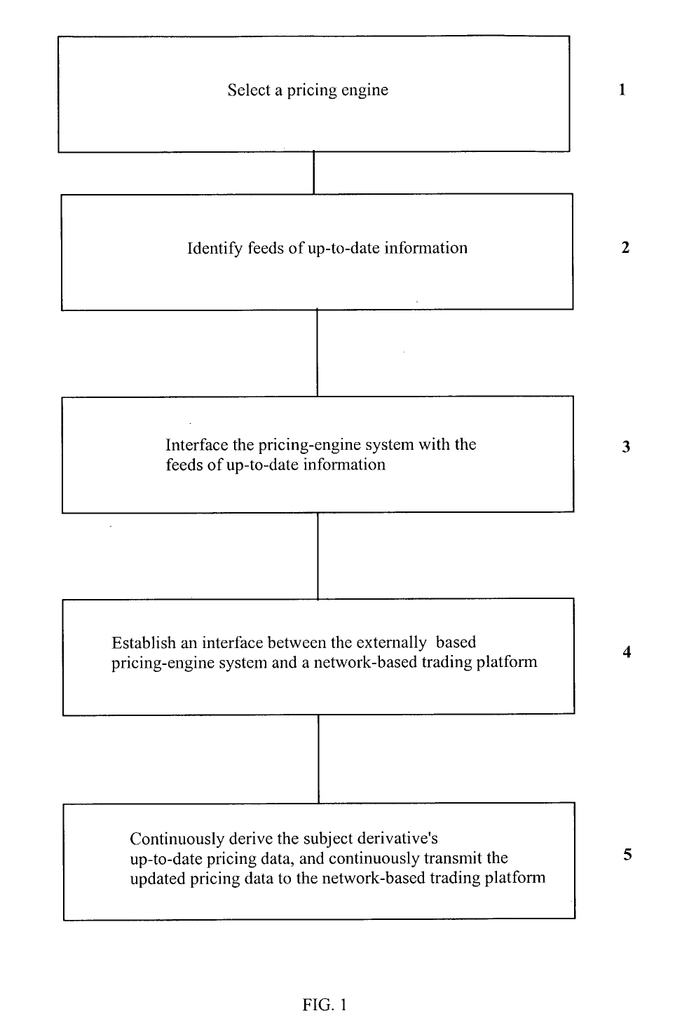

FIG. 1 is a flow chart of a method of the invention for calculating up-to-date pricing data for complex derivatives, based on feeds of up-to-date information, using an externally based pricing-engine system, and continuously transmitting the pricing data to a network-based trading platform. Preferably, the pricing engine's feed of up-to-date information is continuously received electronically from one or more network addresses. More preferably, the up-to-date information is received in real time by way of the Internet.

In the first step (Box 1), the system administrator selects a pricing engine, comprising a system of hardware and software. The pricing-engine software runs pricing models, comprising specific algorithms, to process values assigned to one or more price-affecting variables, and derives a derivative price. The values for the price-affecting variables are continuously updated based on one or more feeds of up-to-date information. The pricing engine software continuously derives up-to-date derivative prices.

Software that is more complicated is generally required to price derivatives that are more complex; to process more price-affecting variables; and where higher accuracy and/or efficiency are desired. More sophisticated pricing models take into account a higher number of price-affecting variables. And, in general, hardware that is more powerful is required for software that is more complex. The system administrator balances these and other factors to select each of the appropriate pricing model, software, and hardware for the pricing engine. The pricing engine is located externally from the network-based trading platform, preferably, at a remote location.

The next step, as indicated in Box 2, is to identify feeds of up-to-date information, preferably, network addresses accessible by network connections, such as Internet addresses. Preferably, such network addresses can automatically provide a continuous stream of up-to-date information. Specific feeds of up-to-date information correspond to specific price-affecting variables that are processed by the pricing-engine system. The system administrator can readily select the appropriate up-to-date information feeds depending on the derivative analyzed (the “subject derivative”), the sophistication of the pricing-engine system, and the price-affecting variables that are taken into account by the pricing model. For example, if a particular stock price is identified as a price-affecting variable, one preferred up-to-date information feed sources is a stream of real-time market prices for that stock.

The next step (Box 3), is to interface the pricing-engine system with the feeds of up-to-date information. A preferred interface is abstracting software to process the up-to-date information feed into a form processible by and compatible with the pricing-engine software. The system administrator selects appropriate abstracting software to continuously digest the up-to-date information and assign up-to-date values to the price-affecting variables for further processing by the pricing engine. Such software is well known in the art.

The forth step, shown in Box 4, is to establish an interface between the externally based pricing-engine system and a network-based trading platform. The interface's purpose is to electronically transmit pricing data—derived by the pricing engine—to the trading platform. Preferably, the interface is established by software that directly writes the pricing data via a network connection into mapped locations of the trading platform's cache memory.

As illustrated by Box 5, the pricing-engine system continuously processes the up-to-date information feeds, continuously assigns values to price-affecting variables, and continuously derives up-to-date pricing data for the subject derivative. The updated pricing data is continuously transmitted to the network-based trading platform for investor use. An exemplary system for practicing the method of FIG. 1 is described below.

5.1 Architecture

5.1.1 Up-to-Date Information Feed Sources

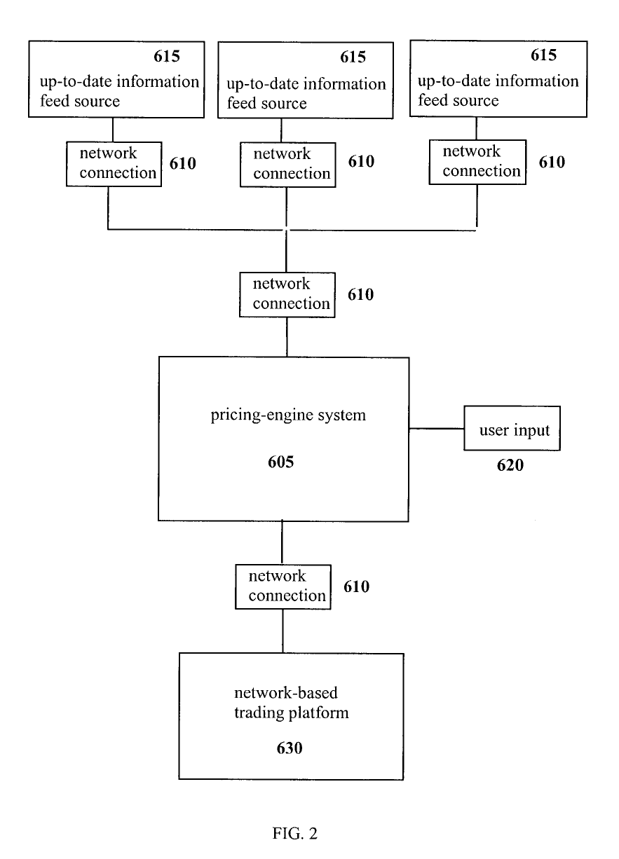

FIG. 2 shows the relationship between the feeds of up-to-date information and the pricing-engine system. Pricing-engine 605 accepts up-to-date information from information feed sources 615, preferably, through network connections 610. Alternatively, up-to-date information can be input to pricing engine 605 using other methods, for example, manual entry by keyboard.

There are many sources of information feeds. Typically, such sources are accessible by way of network connections, preferably, electronically via the Internet and the World Wide Web. Up-to-date information respecting price-affecting variables is downloaded from feeds 615 to pricing engine 605 in a continuos stream from services such as, Reuters Market Data Services or Bloomberg Information by methods well known in the art.

The system administrator can readily access the necessary network addresses to continuously download up-to-date information, preferably, on a real-time basis. In one embodiment, pricing-engine system 605 accepts a continuous stream of market prices for publicly traded commodities, for example, from Teknekron (TiBCO) (http://www.tibco.com); Reuters (www.reuters.com), which sources can provide real-time equity prices, real-time foreign-exchange (FX) rates, and real-time yield curves.

5.1.2 Externally Based Pricing-Engine System

5.1.2.1 Hardware of the Pricing-Engine System

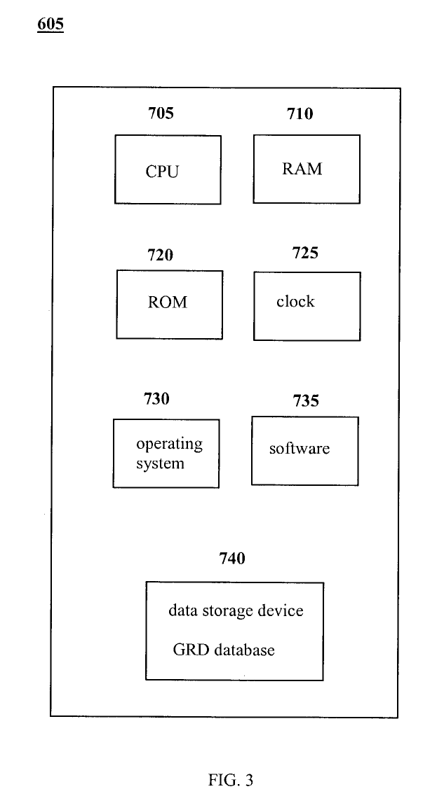

Any conventional computer workstation or server with memory and processing capability sufficient to support the particular pricing-engine software can serve as hardware for pricing-engine system 605. As shown in FIG. 3, pricing-engine system 605 comprises central processor unit (“CPU”) 705, random access memory (“RAM”) 710, read only memory (“ROM”) 720, clock 725, operating system 730, software of the invention 735, and data-storage device 740.

The operating system 730 should be robust and provide for security of the data in storage. Exemplary operating systems include LINUX and UNIX.

Data-storage device 740 stores underlying market data, real-time prices, information necessary to process real-time data, and other data as required by the pricing engine's algorithms. The data-storage device should provide for re-writable data and should provide redundancy via mirroring or error correction (RAID), and it should have a fast interface to the operating system so that data is readily available. Suitable data-storage devices include hard disks.

5.1.2.2 System administrator Entry of Instrument Data and Global Reference Data

Using input 620 (FIG. 2), the system administrator enters the appropriate set-up data for each financial instrument (subject derivative) for which pricing data is to be derived and the global-reference data into a database (“GRD database” 740, FIG. 3). This is one-time setup for an automatic process in which pricing data is continuously derived based on up-to-date information. Such data is particular to the pricing-engine software. Examples of such set-up data include the class of derivative; price-affecting variables; the derivative's relevant times, such as maturity or expiration date etc.; the identity, nature, and amount of any underlying commodities; and the form and nature of the pricing data desired, such as a dollar amount, a dollar range, a bid-ask price, or a value for a greek, etc. If the current-information feeds 615 are network based, the system administrator further inputs the appropriate network addresses from which up-to-date information is continuously downloaded.

5.1.3 Software of the Pricing-Engine System

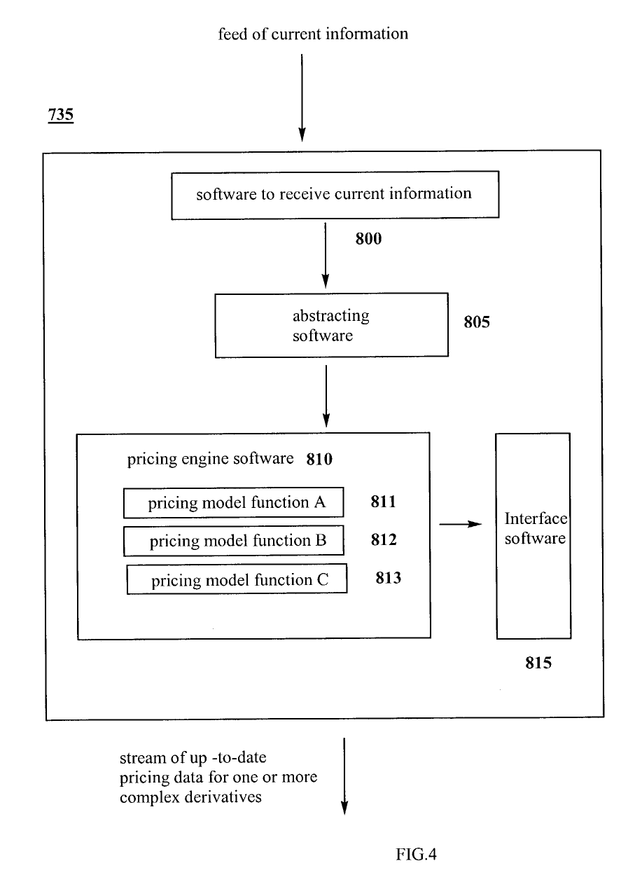

As shown in FIG. 4, pricing engine software 735, continuously derives up-to-date pricing data for the subject derivative. The feed of up-to-date information is received by receiving software 800, such as software offered by Teknekron (TiBCO). Abstracting software 805 processes the up-to-date information feed into a form digestible by pricing-engine software 810. The system administrator selects appropriate abstracting software to continuously digest the information and assign up-to-date values to the price-affecting variables. Such software is well known in the art. Abstracting software 805 continuously transmits the abstracted data, such as values for the price-affecting variables to pricing-engine software 810. Pricing-engine software 810 derives pricing data using the appropriate pricing-model function (e.g., 811, 812, and/or 813). Interfacing software 815 interfaces with network-based platform 630 (FIG. 2). Interfacing software is well known in the art and commercially available or easily developed by those of skill in the art. For example, interfacing software can be built using UDP or TCP/IP network protocols.

Software for performing each of these functions is commercially available or can readily be designed by one of skill in the art. The pricing engines and models for use in the invention are discussed in more detail below.

5.1.3.1 Complex Pricing Engine Models

When specially tailored, exotic derivatives—which are typically associated with several underlying stochastic processes—offered by a financial institution do not correspond to standard exchange-traded products, sophisticated and complex pricing models are required for accurate valuation. Such complex models require powerful hardware and computing resources to estimate up-to-date or real-time prices in an efficient, timely manner. The Black-Scholes differential equation, derived in the early 1970s, has been influential in the development of increasingly sophisticated and complex pricing and hedging models see JOHN C. HULL, OPTIONS, FUTURES, AND OTHER DERIVATIVES 234-297 (5th ed. 2002), hereby incorporated by reference herein. Sophisticated pricing models to price complex and exotic derivatives are now well known in the art. For a detailed discussion and disclosure of sophisticated pricing models see JOHN C. HULL, OPTIONS, FUTURES, AND OTHER DERIVATIVES (5th ed. 2002), hereby incorporated by reference herein. Preferably, the pricing model used in the up-to-date invention valuates derivatives based on real-time pricing information obtained from networked market data services, such as Teknekron (TiBCO) (http://www.tibco.com); Reuters (www.reuters.com); and/or EDG Rate Publisher as discussed in Section 5.1.1 above.

Suitable pricing models for use in the invention include those disclosed in U.S. Patent Application Publication No. 2002/0073007 A1 (published Jun. 13, 2002), hereby incorporated herein by reference. This publication discloses pricing models for valuing options comprising a plurality of underlying assets. The model accounts for drift and volatility parameters.

Other suitable pricing models for use in the invention are disclosed in U.S. Pat. No. 6,381,586 (issued Apr. 30, 2002), hereby incorporated herein by reference. This patent discloses computer-mediated methods for pricing derivative securities using quasi Monte Carlo sequences.

U.S. Pat. No. 6,061,662 (issued May 9, 2000), hereby incorporated herein by reference, discloses a Monte Carlo based system for pricing exotic derivative securities that can be used in combination with a real-time valuation service.

U.S. Pat. No. 6,173,276 (issued Jan. 9, 2001), hereby incorporated herein by reference, provides systems useful in valuing options based on finite difference solutions of the Black-Scholes partial differential equation. The methods and software can differentiate the Black-Scholes equation with respect to any of its parameters to form equations for the greeks. These new equations are then automatically discretized and solved along with the Black-Scholes equation. Boundary and initial conditions for the new quantities must be provided.

U.S. Pat. No. 6,418,417 (issued Jul. 9, 2002), hereby incorporated by reference herein, discloses systems and methods for taking into account weather histories and weather forecasts in valuating derivatives.

5.1.4 Network-Based Trading Platform

As shown in FIG. 2, the subject derivative's pricing data is electronically transmitted to network-based trading platform 630. Any platform that provides investors with an interface offering information concerning financial investment is a suitable network-based trading platform for use in the invention. Preferably, network-based trading platform 630 provides pricing information regarding one or more commodities, preferably, listed commodities, such as stocks, bonds, futures, options, warrants, swaps, real estate, mortgages (interest rates), currency, or precious metals. It is also preferable that network-based trading platform 630 be accessible to the public, for example, through the Internet. It further preferable that network-based trading platform 630 provides a platform for investors to electronically buy and sell the derivatives priced by the methods and systems of the invention. Examples of network-based trading platforms suitable for practice of the invention include, but are not limited to, Ore Software (http://www.orcsoftware.com); Imagine.com Communications (http://www.imagine.com); and AQTOR software by Actant, Inc (http://www.actant.com).

5.1.5 Interface of the Pricing-Engine System to Network-Based Trading Platforms

In a preferred embodiment of the invention, illustrated in FIG. 2, pricing data derived by pricing-engine system 605 is electronically transmitted to network-based trading platform 630, through interfacing software 815 (FIG. 4) by way of network connection 610. Preferably, the pricing data is electronically transmitted to network-based trading platform 630 via the Internet.

The feed from pricing engine 605 to network-based trading platform 630 can be implemented by standard TCP/IP or the equivalent. Preferably, the interface is set up to write pricing data from pricing-engine system 605 directly into mapped locations in the cache memory used by network-based trading platform 630. The mapped values are continuously updated by pricing-engine system 605. To achieve the highest performance, preferably, the cache memory is RAM.

As new pricing data is derived by pricing engine 605, it is pushed from pricing-engine system 605 into the proper location as mapped in the internal cache memory serving network-based trading platform 630. Preferably, pricing-engine system 605 and network-based trading platform 630 operate asynchronously. That is, network-based trading platform 630 selects the value residing in the cache location at the time that network-based trading platform 630 does a read for the subject derivative's pricing data. Pricing data can be pushed often enough to provide up-to-date, preferably, real-time data with respect to the rate that network-based trading platform 630 reads the data. In practice, immediately following a push of pricing data, a system-level message (a service call-back routine) is generated to inform network-based trading platform 630 that new pricing data has just been written into memory for reading.

When network-based trading platform 630 requests pricing data for a new derivative (an entry that is not already in cache), a new cache entry is created and a request for pricing data pertaining to the new subject derivative is forwarded to pricing engine 605. Pricing engine 605 recalls the pricing-model function (e.g., 811-813, FIG. 4) or algorithm for that particular derivative, begins to collect required inputs (e.g., up-to-date information feeds 615, FIG. 2), and then continuously updates the corresponding mapped cache values of platform 630 with pricing data via the network connection.

Pricing engine 605 can be interfaced with any network-based trading platform that allows the system administrator to select pricing modes. For example, where the network-based trading platform runs on a Microsoft Windows terminal, a dynamic linked library (.dll file) is written in an applications program interface framework conforming to the requirements of the trading platform. This gives the trading platform the ability to call for pricing data from pricing engine 605, as if it were calling a standard built in function. Pricing engine 605 then returns the data computed for the requested instrument. Such methods are well known to those skilled in the art.

5.2 Definitions

As used herein, the term “derivative security” or “derivative” means a financial instrument whose price depends on or is derived from one or more underlying assets. Typically, a derivative gives the owner the right to buy or sell the set of underlying commodities at the price set in the agreement within a specified time or on a specified date. Common examples of derivative securities include options, warrants, and futures contracts.

As used herein, the phrase “complex derivative” generally refers to derivatives that are difficult to accurately price because multiple variables and/or non-linear or discontinuous relationships should be taken into account and, therefore, complex mathematical formula are required. In one sense, complex derivative means a financial instrument comprised of a two or more derivatives, for example a plurality of grouped together derivatives. Complex derivative also means a derivative having one or more underlying assets that: (1) results in a non-linear payoff; (2) have payoffs dependent on a maxim value attained by a variable during a period of time; (3) have payoffs dependent on the average value of a variable during a period of time; (4) have exercise prices that are functions of time; or (5) where exercising one option automatically gives the holder another option; or (6) have payoffs dependent on a future interest rate. Examples of complex derivatives include, but are not limited to, packages, nonstandard American options, forward start options, compound options, chooser options, barrier options, binary options, lookback options, shout options, Asian options, options to exchange one asset for another, basket options, hedging issues, and static options replication, each as defined in JOHN C. HULL, OPTIONS, FUTURES, AND OTHER DERIVATIVES 435-449 (5th ed. 2002), hereby incorporated by reference herein.

As used herein, the phrase “subject derivative” means the derivative for which pricing data is to be derived using the methods and systems of the invention.

As used herein, the phrase “pricing data” means any data that is relevant to the price of the subject derivative. Pricing data can be in any form, for example, but not limited to, a dollar amount, a dollar range, a bid-ask price, or a value for a greek, etc. Preferably, the pricing data is the current market price for the subject derivative.

As used herein, the phrase “network-based trading platform” means a platform, accessible by way of a network that provides investors with access to pricing information in connection with commodities. Preferably, a network-based trading platform further provides automated, network-based trading services. A preferred network-based trading platform allows a trader to enter an order to buy or sell a commodity, which order is transmitted to an introducing broker or to the central system of the applicable exchange. A preferred network based trading platform for use in the invention is the company Orc Software (http://www.orcsoftware.com) that provides architecture for trading commodities in real time.

As used herein, the phrase “externally based” with reference to the relationship between the pricing engine and the network-based trading platform, means that the system and hardware which comprises the pricing engine is separate from the system of hardware and software that comprises the network-based trading platform. The pricing engine and the network-based trading platform interact by way of a network connection.

As used herein, the phrase “price-affecting variable” is used in reference to the subject derivative. It means any variable that can affect the price of a derivative security. Thus, the meaning of “price-affecting variable” includes anything that can affect the price of one or more of the subject derivative's underlying commodities or of the derivative itself. For example, if a particular stock price is identified as a price-affecting variable, up-to-date information feed sources might include not only the real-time prices of the stock, but economic forecasts as well. Examples of price-affecting variables include, but are not limited to, real-time prices of exchange-traded commodities and financial instruments; initial prices; price histories; economic data and commentary, such as interest rates, employment rates, and consumer spending; political commentary; current events; weather-related information, such as rainfall, temperature, or other environmental factors for particular geographical locations; disasters; and terrorist activities, all on a local, national, and world basis. For example, the pricing model used to price a derivative might take into account Minnesota rainfall data as a price-affecting variable for a derivative having underlying grain futures.

As used herein, the term “network” means any system of two or more interconnected computers. Examples of networks include, but are not limited to, the Internet and other Wide Area Networks (WANs), and Local Area Networks (LANs).

A preferred network for use in the invention is the Internet. When capitalized, the term “Internet” refers to the collection of computers, computer networks, and gateways that use TCP/IP protocols. Internet resources for transferring information include File Transfer Protocol (FTP) and Gopher. But preferably, information is transmitted and received over the Internet by way of the World Wide Web. The World Wide Web is the collection of servers and computers that use Hypertext Transfer Protocol (HTTP) for transferring data files. Users interact with the World Wide Web through web pages, which are logical blocks of information formatted with Hypertext Markup Language (HTML) or Extensible Markup Language (XML). Web pages are identified by a Uniform Resource Locator (“URL”), which is a special syntax identifier (network address) defining a communications path to the web page.

A browser is a program capable of submitting a request for a web page identified by a URL. Retrieval of web pages is generally accomplished with an HTML- or XML-compatible browser that browses web sites. A web site is a group of related HTML documents and associated files, scripts, and databases that is served up by an HTTP server on the World Wide Web.

As used herein, the phrase “network connection” means any channel by which a person, party, or business entity can interface or communicate with a network. Examples of network connections include, but are not limited to, telephone lines by way of internal or external modems, digital subscriber lines (“DSL”), voice mail and voice pages; dedicated data lines; cellular phone communication; communication by way of satellite; and cable television lines.

As used herein, the term “platform” means a system of software and hardware located on a network that performs a function, such as providing services or information, and which is accessible through a network interface.

As used herein, the term “interface” means a displayed or transmitted, user friendly set of pictures, text, voice statements, or other communication means that provide instructions and protocols indicating how a user is to communicate and interact with a platform. For example, an interface allows a user to direct computer software located on the user's computer or within a network. Examples of interfaces include, but are not limited to, Web pages, e-mail transmittals, voice pages, voice mail instructions, and facsimile transmissions (fax). An interface is displayed or provided by an “interface provider”, for example, a personal computer displaying a Web page interface.

As used herein, the term “automatically” means execution by computer software upon occurrence of an event or satisfaction of a condition without instruction from or intervention of a user.

As used herein, the term “commodity” means any good or service that can be purchased or sold.

As used herein, the phrase “listed commodity” means any commodity that is listed on an exchange. Examples of exchanges include, but are not limited to, the American Stock Exchange, Chicago Board of Exchange, Chicago Board of Trade, International Securities Exchange (options), NASDAQ Stock Market, and the New York Board of Trade.

As used herein, the phrase “exchange rate” means the price listed by an exchange for a listed commodity at a particular time.

### 5.3 CONCLUSION

In view of the above Background, Summary, Figures, and Detailed Description presented above, it is clear that in one embodiment, the invention is directed to a method for providing pricing data for a derivative to a network-based trading platform comprising:

(a) receiving information relating to the derivative;

(b) using a pricing engine to automatically process the information to derive pricing data for the derivative;

(c) interfacing the pricing engine with the network-based trading platform; and

(d) automatically transmitting the pricing data from the pricing engine to the network-based trading platform over a network.

In another embodiment, the invention relates to a system for providing pricing data for a derivative to a network-based trading platform comprising:

(i) a memory storage device;

(ii) a processor connected to the storage device;

(iii) a program for controlling the processor; wherein the memory storage device and the processor are operative with the program to:

(a) receive information relating to the derivative;

(b) control a pricing engine to automatically process the information to derive pricing data for the derivative;

(c) automatically interface the pricing engine with the network-based trading platform; and

(d) automatically transmit the pricing data from the pricing engine to the network-based trading platform over a network.

In still another embodiment, the invention is directed to a computer readable medium programmed with computer software that is operative to cause a system comprising a memory storage device and a processor to perform the steps of:

(a) receiving information relating to a derivative;

(b) using a pricing engine to automatically process the information to derive pricing data for the derivative;

(c) interfacing the pricing engine with a network-based trading platform; and

(d) automatically transmitting the pricing data from the pricing engine to the network-based trading platform over a network.

Although the present invention has been described in considerable detail with reference to certain preferred embodiments and versions, other versions and embodiments are possible. Therefore, the scope of the appended claims should not be limited to the description of the versions and embodiments expressly disclosed herein.

What is claimed is:

1. A method for providing pricing data for a derivative to a network-based trading platform comprising:
(a) receiving information relating to the derivative;
(b) using a pricing engine to automatically process the information to derive pricing data for the derivative;
(c) interfacing the pricing engine with the network-based trading platform; and
(d) automatically transmitting the pricing data from the pricing engine to the network-based trading platform over a network.

2. The method of claim 1, wherein the derivative is a complex derivative.

3. The method of claim 1, wherein the information relates to one or more variables that affect the derivative's price.

4. The method of claim 1, wherein the information is received over a network.

5. The method of claim 1, wherein automatically transmitting the pricing data comprises writing the pricing data to cache memory accessed by the network-based trading platform.

6. The method of claim 5, wherein the pricing data is written to a hash table residing in the cache memory.

7. The method of claim 1, wherein the pricing data transmitted to the network-based trading platform is available to investors by way of one or more web pages.

8. The method of claim 1, further comprising:
(e) receiving updated information relating to the derivative;
(f) using the pricing engine to automatically process the updated information to derive updated pricing data for the derivative;
(g) interfacing the pricing engine with the network-based trading platform; and
(h) automatically transmitting the updated pricing data from the pricing engine to the network-based trading platform over the network.

9. The method of claim 1, wherein the pricing engine is external from the network-based trading platform.

10. A system for providing pricing data for a derivative to a network-based trading platform comprising:
(i) a memory storage device;
(ii) a processor connected to the storage device;
(iii) a program for controlling the processor; wherein the memory storage device and the processor are operative with the program to:
(a) receive information relating to the derivative;
(b) control a pricing engine to automatically process the information to derive pricing data for the derivative;
(c) automatically interface the pricing engine with the network-based trading platform; and
(d) automatically transmit the pricing data from the pricing engine to the network-based trading platform over a network.

11. The system of claim 10, wherein the derivative is a complex derivative.

12. The system of claim 10, wherein the information relates to one or more variables that affect the derivative's price.

13. The system of claim 10, wherein the information is received over a network.

14. The system of claim 10, wherein automatically transmitting the pricing data comprises writing the pricing data to cache memory accessed by the network-based trading platform.

15. The system of claim 14, wherein the pricing data is written to a hash table residing in the cache memory.

16. The system of claim 10, wherein the pricing data transmitted to the network-based trading platform is available to investors by way of one or more web pages.

17. The system of claim 10, wherein the memory storage device and the processor are further operative with the program to:
(e) receive updated information relating to the derivative;
(f) control the pricing engine to automatically process the updated information to derive updated pricing data for the derivative;
(g) automatically interface the pricing engine with the network-based trading platform; and
(h) transmit the updated pricing data from the pricing engine to the network-based trading platform over the network.

18. A computer readable medium programmed with computer software that is operative to cause a system comprising a memory storage device and a processor to perform the steps of:
(a) receiving information relating to a derivative;
(b) using a pricing engine to automatically process the information to derive pricing data for the derivative;
(c) interfacing the pricing engine with a network-based trading platform; and
(d) automatically transmitting the pricing data from the pricing engine to the network-based trading platform over a network.

19. The computer readable medium of claim 18, wherein the derivative is a complex derivative.

20. The computer readable medium of claim 18, wherein the information relates to one or more variables that affect the derivative's price.

21. The computer readable medium of claim 18, wherein the information is received over a network.

22. The computer readable medium of claim 18, wherein automatically transmitting the pricing data comprises writing the pricing data to cache memory accessed by the network-based trading platform.

23. The computer readable medium of claim 22, wherein the pricing data is written to a hash table residing in the cache memory.

24. The computer readable medium of claim 18, wherein the pricing data transmitted to the network-based trading platform is available to investors by way of one or more web pages.

25. The computer readable medium of claim 18, wherein the computer software is operative to further causes the system comprising the memory storage device and the processor to perform the additional steps of:
(e) receiving updated information relating to the derivative;
(f) using the pricing engine to automatically process the updated information to derive updated pricing data for the derivative;
(g) interfacing the pricing engine with the network-based trading platform; and
(h) automatically transmitting the updated pricing data from the pricing engine to the network-based trading platform over the network.
